(19) United States
(12) Patent Application Publication
(10) Pub. No.: US 2009/0304366 A1
(43) Pub. Date: Dec. 10, 2009

(54) RELIABLE VIDEO RECORDING ON OPTICAL DISCS

(75) Inventor: Srinivas Rao Kudavelly, Hyderabad (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,536

(22) PCT Filed: Dec. 17, 2007
(86) PCT No.: PCT/IB2007/055142

§ 371 Date: Jun. 17, 2009

(30) Foreign Application Priority Data
Dec. 21, 2006 (EP) 06126777.9

(51) Int. Cl. H04N 5/00

(52) U.S. Cl. 386/126; 386/E05.064

(57) ABSTRACT

This invention relates generally to a method of recording video information onto an optical disc of the rewritable type. The invention relates to determining in real time whether errors were encountered during recording a physical sector and generating error sector information comprising a list of sectors wherein errors were encountered during recording. The error sector information is recorded on disc, preferably in VRMI user data to playback compatibility with standard players. During playback, error sector are skipped from reading. Advantageously, a buffer cell is created for information recorded in error sectors so that seamless playback is possible. Advantageously, when formatting the disc, the error sector information is not deleted. Advantageously, the error sector information is used to inform the user about the disc quality.

### FIELD OF THE INVENTION

The present invention relates to a method of recording video information onto an optical disc of the rewritable type. The present invention also relates to a method of formatting said optical disc and a method of playback of video information from said optical disc. This invention also relates to a device for recording or for playback of video information onto/from an optical disc of the rewritable type implementing such recording, formatting and playback methods. The invention is particularly relevant for optical disc recording devices.

### BACKGROUND OF THE INVENTION

Use of different type of optical disc belonging to the DVD (Digital versatile disc) family for recording and storage of both data and audio-video content is becoming widespread. Several types of rewritable media, including DVD-RAM, DVD-RW and DVD+RW are available for such purposes. A known issue is that in time the recording quality degrades, for example due to scratches, fingerprint or damage to media in the re-writing process.

One known solution for alleviating such problem is to make use of the defect management, wherein predefined spare areas of the medium are reserved for defect replacement. Defect management consists of physical addresses of defective physical sectors being maintained in a defect table, and the corresponding logical addresses of said defective physical sectors being mapped to usable physical sectors. However, when defect management is used, the data transfer rate may become slower, as reading information from replacement sectors involves movement of the optical head and seek operations.

Consequently, the optional defect management is not used in the case of recording video content, as a minimum data transfer rate need to be guaranteed in order to avoid image freezing during playback. In general, when recording real time video content, it is left to the application to handle this warning/error codes generated during recording and take corrective actions such as continue recording (ignore the error, which will result in audio-video hiccups during playback) or retry to write the content on the sector generating the warning/error code or retry to write the content on subsequent sectors by skipping said sectors.

US patent application No. 2004/0208097 describe a method of implementing defect management wherein when errors are detected when reproducing non video data, a linear replacing algorithm is applied; while when reproducing video data, the physical identification of error sectors is maintained on a separate list in the defect management area and such sectors are not replaced. It is noted that defect management is always available on DVD-RAM discs and it is optional on DVD-RW and DVD+RW discs. Problems with the above described method are that it is specific to DVD-RAM and it requires that defect management is used.

### SUMMARY OF THE INVENTION

It is an object of the invention to provide a solution to the above problem of handling defects when recording video information obviated at least one of the above mentioned problems. The object of the invention is reached by a method of recording video information onto an optical disc of the rewritable type according to claim 1. Accordingly, error sector information comprising a list of logical sectors corresponding to the physical sectors wherein errors were encountered during recording is generated and said information recorded onto the optical disc. Consequently, information with respect to the physical sectors wherein errors were encountered during recording is made available to the application at logical level without the need to use defect management. Moreover, said method can be implemented independent of the type of optical disc.

The logical recording space of the optical disc usually comprises a video zone for recording said video information and for recording corresponding management information, the information in the video zone being arranged according to a video recording format. In an advantageous embodiment of the invention, the error sector information is recorded into a predetermined area reserved for recording temporary information or for recording optional information for improving functionality, such as the Video Recorder Manager User Data. When recording an optical disc, a known problem when recording any information not directly mandated by a recording format is that the resulting optical disc may become unsuitable for playback and/or recording for other devices that do not recognize such additional information. Recoding the recovery information within a specified disc area for recording temporary information or for recording optional information for improving functionality, such as the Video Recorder Manager User Data has the advantage that other recording devices expect that said recovery information may be present and the recovery information may not be accessible to them. Therefore legacy devices, that is devices not enabled to perform recovery of video information according to the invention, would be able to use the disc by ignoring the recovery information, so that the recorded optical disc remains compatible with the used recording format.

Usually the video information is recorded as video objects comprising a sequence of contiguously recorded cells. In an advantageous embodiment of the invention, an additional cell comprising the video information recorded in the physical sectors wherein errors were encountered during recording is generated. Cells are the smallest units that can be referenced independently in a playlist. Consequently this provides the advantage that an updated playlist can be generated wherein the parts comprising the defects are skipped from playback, therefore improving robustness. In an embodiment the additional cell is a buffer cell not referenced by any playback sequences comprised in the management information. Hence such cell is not playback and updating playlist is not necessary anymore.

In an embodiment of the invention the error sector information further comprises statistical information with respect to logical sectors corresponding to physical sectors wherein errors were encountered during recording, such as the percentage of said sectors from the total number of sectors on disc. This provides the advantage that the percentage number of error sectors on the disc can be computed and the user informed about the disc status. Furthermore, the user may be queried whether he/she wishes to continue recording and take user consent before recording.

This application also relates to a method of playback of video information, the method comprising determining that a logical sector or a group of logical sectors wherein errors referred to in errors sector information is in playback proximity to a logical sector wherein information recorded therein is being presently played back and deciding to jump the playback to information recorded to a sector succeeding the sector or a group of sectors wherein errors were encountered during recording. When the apparatus is aware that at close proximity erroneous sectors are present, then it can initiate a skip to ensure enhanced playability.

This application also relates to a method of formatting, the method comprising reading the error sector information and storing said error sector information in a temporary buffer, formatting the optical disc, recording the error sector information. This ensures that the enhanced playability/recordability of the optical disc are maintained after the formatting operations, as the information with respect to defect sectors is preserved.

The invention also relates to an optical recording apparatus for recording video information onto an optical disc of the rewritable type, enabled to either record and/or playback video information according to a suitable method according to the invention.

The invention also relates to a computer software program that when executed on suitable processor enables an optical recording apparatus to either record and/or playback video information according to a suitable method according to the invention.

These and other aspects of the invention are apparent from and will be explained with reference to the embodiments described hereinafter.

### BRIEF DESCRIPTION OF THE DRAWINGS

The features and advantages of the invention will be further explained upon reference to the following drawings, in which:

FIG. 1 illustrates schematically an optical disc of the rewritable type;

FIG. 2 shows schematically an optical drive wherein the invention is practiced;

FIG. 3 illustrates schematically the data information structure on an optical disc of the rewritable type suitable for recording video information;

FIG. 4 illustrates schematically a possible structure of a DVD-Video Zone on an optical disc of the rewritable type

FIG. 5 illustrates by means of a flow diagram a method of recording video information onto an optical disc according to several embodiments the invention;

FIG. 6 illustrates by means of a flow diagram a method of playback of video information onto an optical disc according to an embodiment the invention;

FIG. 7 illustrates by means of a flow diagram a method of formatting an optical disc according to an embodiment the invention.

### DETAILED DESCRIPTION OF THE PREFERRED EMBODIMENTS

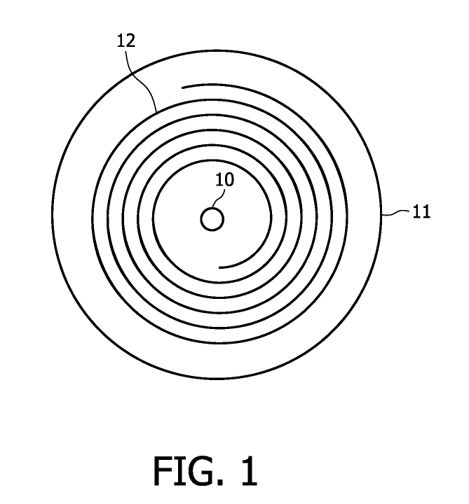

FIG. 1 illustrates schematically an optical disc 11 having a track 12 and a central hole 10. The track 12, being the position of the series of (to be) recorded marks representing information, is arranged in accordance with a single spiral pattern constituting substantially parallel tracks on an information layer. The optical disc may comprise one or more information layers of a recordable type. Known examples of rewritable optical discs are CD-RW, or DVD+/-RW, DVD-RAM or BD-RE. For example, further details about the physical structure and addressing information for DVD+RW or DVD-RW optical discs can be found in references ECMA-337 and ECMA-338, respectively. The information is represented on the information layer by recording optically detectable marks along the track, for instance crystalline or amorphous marks in phase change material. The track 12 on the optical disc is indicated by a pre-embossed track structure provided during manufacture of the blank optical disc. The track structure is constituted, for example, by a pregroove, which enables a read/write head to follow the track during scanning.

The track structure of recordable disc comprises variation of a physical parameter, known in the art as a wobble, usually in the form of periodical radial displacements of the groove from an average centerline. The periodic wobble is further modulated so that further information is stored, such as physical addresses indicating the location of units of information. Said information may further include specific synchronizing marks for locating the start of such information blocks. The position information is encoded in groups comprising a predetermined number of modulated wobbles. The smallest independently addressable unit is known as a physical sector.

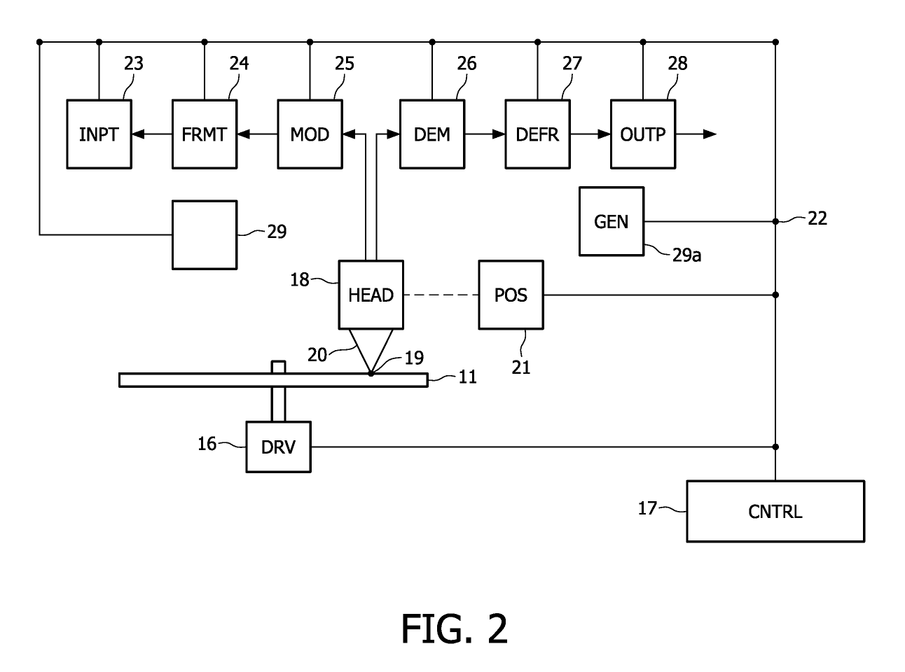

FIG. 2 illustrates schematically a recording device for writing information on the optical disc 11 as illustrated with reference to FIG. 1.

The recording device is provided with recording means for scanning the track on the optical disc, the recording means comprising a drive unit 16 for rotating the optical disc 11, a head 18, a positioning unit 21 for coarsely positioning the head 18 in the radial direction on the track, and a control unit 17. The head 18 comprises an optical system of a known type for generating a radiation beam 20 guided through optical elements for focusing said radiation beam 20 to a radiation spot 19 on the track 12 of the optical disc 11. The radiation beam 20 is generated by a radiation source, e.g. a laser diode. The head further comprises (not shown) a focusing actuator for moving the focus of the radiation beam 20 along the optical axis of said beam and a tracking actuator for fine positioning of the radiation spot 19 in a radial direction on the center of the track. The tracking actuator may comprise coils for radially moving an optical element or may alternatively be arranged for changing the angle of a reflecting element.

For reading information, the radiation reflected by the information layer is detected by a detector of a usual type, e.g. a four-quadrant diode, in the head 18 for generating a read signal and further detector signals, such as a tracking error and a focusing error signal for controlling said tracking and focusing actuators.

For recording information the radiation beam 20 is controlled to create optically detectable marks in the recording layer. For this purpose, the recording device comprises write processing means for processing input information to generate a write signal to drive the head 18, which write processing means comprise an input unit 23; and data processing means comprising a formatter 24 and a modulator 25.

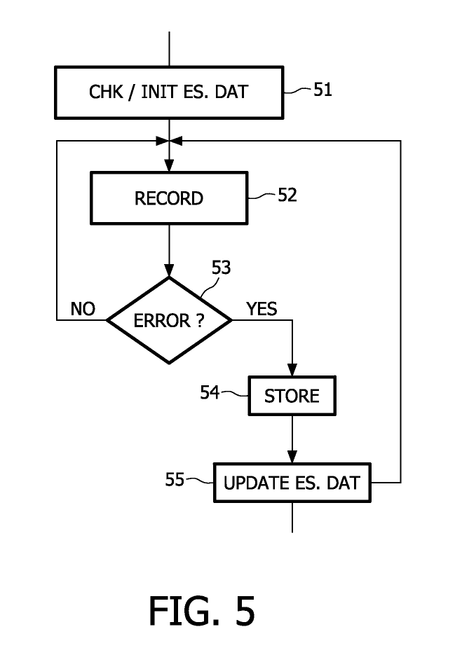

The control unit 17 controls the recording and retrieving of information onto and from the optical disc 11, and may be arranged for receiving commands from a user or from a host computer. To this end, the control unit 17 may comprise control circuitry, for example a microprocessor, a program memory and control gates, thereby constituting suitable means for performing the procedures described hereinafter with reference to FIGS. 5, 6 and 7. The control unit 17 may also be implemented as a state machine in logic circuits. The control unit 17 is connected via control lines 22, e.g. a system bus, to said input unit 23, formatter 24 and modulator 25, to the drive unit 16, and to the positioning unit 21.

The input unit 23 receives and pre-processes the user information. For example, when processing audio-video information, the input unit 23, may comprise compression means for compressing input signals such as analog audio and/or video, or digital uncompressed audio/video. Suitable compression means are described for audio in WO 98/16014-A1, and for video in the MPEG2 standard (ISO-IEC 13818). The input signal may alternatively be already encoded. The output of the input unit 23 is passed to the formatter 24 for adding control data and formatting the data according to a recording format, e.g. by adding error correction codes (ECC) and/or interleaving. For computer applications units of information may be interfaced to the formatter 24 directly. The formatted data from the output of the formatter 24 is passed to the modulation unit 25, which comprises for example a channel coder, for generating a modulated signal, which drives the head 22. Further the modulation unit 25 comprises synchronizing means for including synchronizing patterns in the modulated signal. The formatted units presented to the input of the modulation unit 25 comprise address information and are written to corresponding addressable locations on the optical disc under the control of control unit 17. The control unit 17 is arranged for recording and retrieving position data indicative of the position of the recorded information volumes.

During the recording operation, marks representing the information are formed on the optical disc. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. Writing and reading of information for recording on optical disks and usable formatting, error correcting and channel coding rules are well-known in the art, e.g. from the CD system (IEC 908).

For reading, the read signal is processed by a read processing unit comprising a demodulator 26, a de-formatter 27 and output unit 28 for outputting the information. The functioning of the demodulator 26, the de-formatter 27 and the output unit 28 is controlled by the controller 17. Hence, retrieving means for reading information include the drive unit 16, the head 18, the positioning unit 21 and the read processing unit.

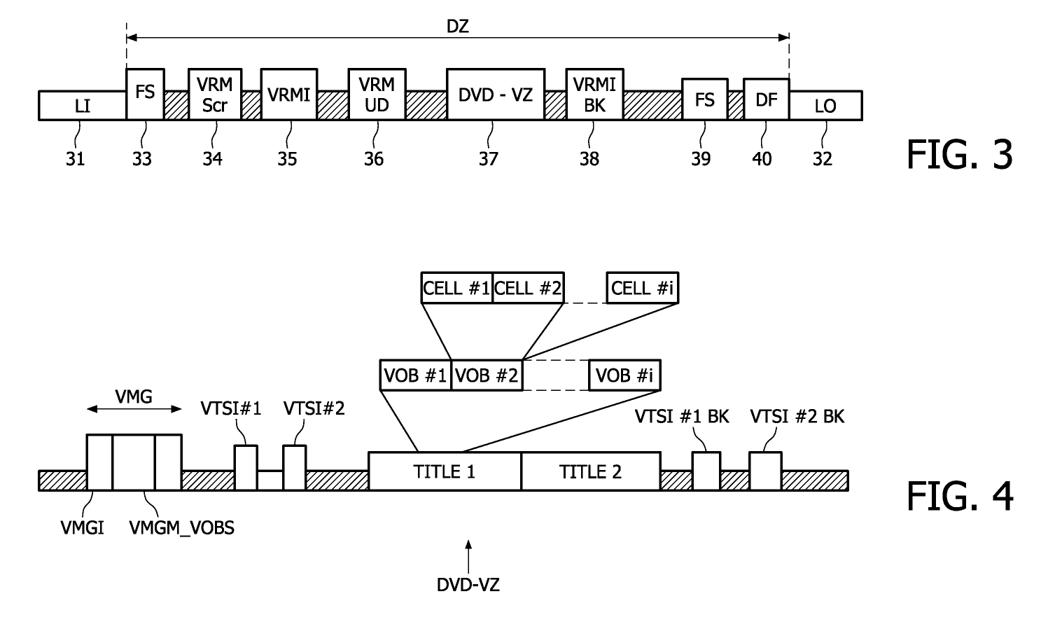

The optical disc 11 is intended for carrying user information according to a recording format, to be playable on standardized playback devices. The recording format includes the way information is recorded, encoded and logically mapped onto the recording area provided by the track 12 and it will be described, by way of example, with reference to FIG. 3. The recordable area is usually subdivided into a lead-in area (LI) 31, a data zone (DZ) for recording the information and a lead-out area (LO) 32. The lead-in area (LI) 31 usually comprises basic disc management information and information how to physically access the data zone (DZ), i.e. mapping the recordable area to a logical recording space, and logical sectors to physical sectors. For example, said basic disc management information corresponds to the table of contents in CD systems or the formatting disc control blocks (FDCB) in DVD systems.

The user information recorded in the data zone (DZ) is further arranged according to a logical format, for example comprising a predefined structure of files and directories. Further, at logical level, the user data in the data zone is arranged according to a file system comprising file management information, such as ISO 9660 used in CD systems, available as ECMA-119, or UDF used in DVD systems, available as ECMA-167. Such file management information is mapped on a predefined location on the optical disc 11, usually in or directly after the lead-in area (LI). The user information recorded in the data zone (DZ) may be further arranged according to a recording format, for example comprising a predefined structure of files and directories.

Usually, in case video information is recorded onto the optical disc, this is usually recorded in a separate volume from other data. For example, FIG. 3 further illustrates such an arrangement as used in the case of recording video information and user data onto a DVD+RW disc. The data zone (DZ) is organized as single volume space and may be further divided into a video section and data section. The Video section comprises a video file system 33, a Video Recorder Manager (VRM) scratch area 34, a Video Recorder Manager Information (VRMI) 35 a Video Recorder Manager User Data (VRM_UD) 36, a DVD Video Zone (DVD-VZ) 37 and a backup copy of the Video Recorder Manager Information (VRMI-BK) 38. The optional data section succeeds the video section and it comprises a File system area 39 and the data files 40. The hashed areas in FIG. 3 indicate that the previously described elements of the data zone (DZ) need not be recorded contiguously. The VRM scratch area 34 is an area used by recorders to temporally store data. The Video Recorder Manager Information (VRMI) 35 comprises information with respect for identifying the type of recorder that has generated the DVD-Video menus on the disc. The Video Recorder Manager Information (VRMI) 35 further comprises information whether a data section is present on the disc. The Video Recorder Manager User Data (VRM_UD) 36 are optional data structures that may be stored in one or more files, which may be recorded to add functionality and to improve performance on some recorders.

The video file system 33 comprises a video volume usually comprising at least a VIDEO_RM directory and a VIDEO_TS directory in the root directory. The VIDEO_RM directory usually comprises the following files:
VIDEO_RM.DAT (comprising the VRM scratch information),
VIDEO_RM.IFO (comprising VRMI information) and
VIDEO_RM.BUP (comprising VRMI backup information).

The VIDEO_RM directory may comprise other VRM user data files.

The VIDEO_TS directory usually comprises the following files:
VIDEO_TS.IFO (comprising the Video Manager General information (VMGI)),
VIDEO_TS.BUP (comprising a backup of VMGI), and
a sequence of files for each video title set (VTS), the sequence comprising for each VTS: VTS_{—}01_{—}0.IFO (Video Title Set Information (VTSI) for title #1), VTS_{—}01_{—}1.VOB (VTSTT_VOBS for VTS #1) and VTS_{—}01_{—}0.BUP (comprising a backup of VTSI for title #1).

FIG. 4 illustrates schematically a possible structure of a DVD-Video Zone (DVD-VZ) 47 on an optical disc of the rewritable type. In the order of recording, it usually comprises a Video Manager (VMG), Video Title Set Information (VTSI) for each video title set (VTS), one or several several video title sets (VTS) comprising the video information (TITLE1, TITLE2) and backups (VTSI #1_BK, VTSI #2_BK) of the Video Title Set Information (VTSI) for each video title set (VTS). The Video Manager (VMG) comprises Video Manager Information (VMGI), optionally a video object set VMGM_VOBS and a backup copy of VMGI. The Video Title Set Information (VTSI) comprises management information for enabling playback and trick play of the video titles. A suitable example of the structure of the Video Title Set Information (VTSI), corresponding to the DVD+RW Video recording format, has been disclosed in WO 01/01415, to be inserted here by reference. It is noted that in general the Video Objects for all Titles on the disc are put into a single VTS_Title Video Object Set (VTTS_VOBS) irrespective of the VTS they belong to.

The video information is encoded in a format such as MPEG 2 and stored onto the optical disc as a sequence of cells forming a recording within a video title set (VTS). It is further noted that the single VTS_Title Video Object Set (VTTS_VOBS) may comprises several video objects (VOB#1, VOB#2 . . . VOB#i), each video object comprising a contiguously recorded sequence of cells (cell #1, cell#2 . . . cell#i). The Video Title Set Information (VTSI) further comprises one or more program chains. A program chain is the logical unit to present a part of a Title or Menu. It is composed of the PGC Information (PGCI) on which the order and the essence of the presentation are described and one or more Cells to be presented.

FIG. 5 illustrates by means of a flow diagram a method of recording video information onto an optical disc according to an embodiment the invention.

In initialization step 51 (CHK/INIT ES.DAT) a disc is introduced in the recording apparatus. If the disc is a rewritable disc, the apparatus checks whether the disc is new or not and whether error sector information is available on the disc. If the disc is new (not formatted) in the de-icing step during formatting an empty file corresponding to the error sector information is created. Preferably, such file is placed din the VRM User Data Area. In following said filed will be referred as “VIDEO_ES.DAT”. The existence of “VIDEO_ES.DAT” is indication that the disc contains “error sectors”, for example due to improper handling of the discs, scratches, deterioration due to extensive usage. The main content of the error sector information is a list of logical sectors corresponding to the physical sectors wherein errors were encountered during recording. Preferably the VIDEO_ES.DAT is set as a read-only file, so that it is not deleted inadvertently.

It is noted that in an alternative embodiment of the method the “VIDEO_ES.DAT” file contains apart from the list of logical sectors corresponding to the physical sectors wherein errors were encountered during recording, it contains statistical information like total number of error sectors, total sectors available. Consequently, in this embodiment it is possible that the percentage number of error sectors on the disc is computed and the user is queried whether he/she wishes to continue recording. Using the “VIDEO_ES.DAT” information, the recording apparatus can inform the user about the actual “size/storage” capacity of the disc. The recording is initiated after receiving user confirmation to proceed.

In recording step 42 (RECORD), the recording process is started and the video information is recorded onto the optical disc. In step 53 (ERROR?) it is checked whether a “warning/error code” was returned by the recording means during the real time recording. If not, the recording continues. When such “warning/error code” is received, in step 54 (STORE) the error sector inventory information is updated. In an alternative embodiment such information is not directly recorded onto the disc, but it is kept in a memory buffer and only recorded in step 55 (UPDATE ES.DAT) either periodically (for example each 5 seconds) or after the recording has finished.

It is noted that when the method according to the invention is implemented in an optical recording apparatus, the apparatus is a-priori aware of the erroneous sectors by loading the information in the VIDEO_ES.DAT and can skip those sectors during overwriting a previous recording. Hence this enhances the recording reliability of the optical recording apparatus. Consequently this provides the advantage that an updated playlist can be generated wherein the parts comprising the defects are skipped from playback, therefore improving robustness. In a further embodiment, the additional cell is chosen to be a buffer cell. Buffer cells are cells that are not referenced by any program chain comprised in the Video Title Set Information (VTSI). Hence such buffer cell is not playback and updating playlist is not necessary anymore.

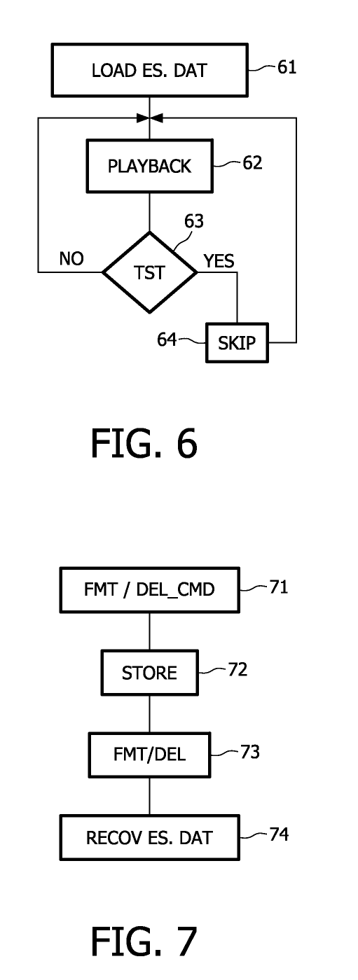

FIG. 6 illustrates by means of a flow diagram a method of playback of video information from an optical disc according to an embodiment the invention. Before the playback is started, in step 61 (LOAD ES.DAT), the error sector information is loaded in a memory. In step 62 (PLAYBACK) playback of the video information takes place. In step 63 (TST), it is tested whether a logical sector or a group of logical sectors wherein errors referred to in errors sector information is in playback proximity to a logical sector wherein information recorded therein is being presently played back. If so, in step 64 (SKIP) a skip (ump) to a logical sector succeeding the defect sectors is generated during playback. As the optical recording apparatus is a-priori aware of the erroneous sectors, it can skip those sectors during playback, and, consequently, there are no Processor MIPS penalties in “retries”.

FIG. 7 illustrates by means of a flow diagram a method of formatting an optical disc according to an embodiment the invention. The process of formatting an optical disc is known, and several options are usually available. The process known in the art as regular formatting is the conventional way of physical formatting used for optical disc such as CD or DVD. After the regular formatting process, the disc is fully formatted at physical level. The formatting process comprises recording the Lead-in area (LI), writing the Data Zone (DZ), writing the Lead-out area (LO), and optionally verification of the Data Zone and initialization of the Defect Management, if defect management is to be used. A second type of formatting process is known in the art as background formatting, which is a formatting process that runs in the background during use of the disc in a recorder. After the Background Formatting process has been completed, the disc is fully physical formatted at physical level. User data may be recorded to the disc during the Background Formatting process. The Background Formatting process may comprise the following steps
Initialization of the Defect Management;
De-icing of the Data Zone, which may be optional, depending on the type of optical discs;
Finalization of the Lead-in and Lead-out Zones;
Early-eject finishing (if applicable);
Restarting the Background Formatting on an early-ejected disc;
Verification (optionally selected by host computer).

In step 71 (FMT/DEL_CMD) a format/delete all command is received. In step 72 (STORE) the error sector information or information allowing recovering the error sector information is stored in a memory. In step 73 (FMT) the format process takes place as described above. In step 74 (RECOV ES.DAT), the error sector information recorded back on the disc is recovered. An optical recording apparatus according to the invention will not delete the error sector information (e.g. the “VIDEO_ES.DAT” file) even if the optical disc is formatted or all the recordings are deleted.

It is noted that during the real-time recording, in case of recording on an unrecorded part of the disc, the optical recording apparatus is not “aware” about the potential “error sectors” on the disc, that is the optical recording apparatus does not known whether a specific area of the disc has manufacturing errors and recording thereon results in errors. Consequently, when optical recording apparatus attempts to record information onto such areas comprising defect, a “warning/error code” will be returned. Known optical recording apparatuses handle such “warning/error code” by taking one of the following actions:
continue recording (Ignore the error, which will result in audio-video hiccups during playback)
   retry to record the information on the “error sector”
retry again to record the information on subsequent sectors by skipping the “error sectors”.

Using the errors sector information as described above it is possible to guarantee the reliability of real-time by means of combining the method of recording video information onto an optical disc as described with reference to FIG. 5 with “pseudo archiving”. In the following a by method of formatting and recording an optical disc according to another embodiment the invention will be described.

When an optical disc is inserted into an optical recording apparatus, the first step is a disc recognition step. According to the invention, as part of the disc recognition step, the optical recording apparatus checks the disc for the possible recording speeds for the recordable disc (say, 2.4×, 4×, 8×). Also, the optical recording apparatus knows the max recording speed capability of the optical drive.

In the recording step, when user sends a command for a real-time recording, according to the invention the optical recording apparatus performs a “pseudo archiving” sub-step by recording dummy information (for example ECC blocks filled with zero or other freely chosen information) at the maximum possible disc speed (for example 8×). During this sub-step error sector information is gathered (if any needs to be gathered) as described in steps 53 and 54 of the method of recording. Optionally, this “pseudo-archiving” operation may also be used to configure the recording real time AV buffer, for example by introducing buffer cells to skip any erroneous sector. The real time AV buffer content is over-written at 2.4× over the dummy information by changing the drive speed. Hence the “pseudo-archiving” is intermixed with a sub-step of recording the real-time information (e.g. the AV content). A real time recording according to this embodiment of the invention is performed in sequence of two alternating sub-step process, namely pseudo-Archiving at a high recording speed, preferably the maximum allowed recording speed, and real time recording of the information at 2.4× by dynamically changing the drive engine speed.

In a particular embodiment, pseudo-archiving comprises recording dummy data written in steps of groups of ECC block (e.g. 16 zero filled EC C blocks), which is system configurable value based on the available hardware memory.

It is noted that, as part of stop recording command from the user, the error sector information is stored on the VRM user data area on the disc.

In an embodiment of the invention, the user may configure the behaviour of the optical recording apparatus, that is the user may chose between a reliable real time recording mode wherein the two sub-step process (pseudo archiving and real time recording) as described above is invoked, or the regular recording mode, comprising using existing/recorded error sector information on the disc.

Upon receiving user confirmation for the choice of the reliable mode two step process, there are several options available for implementing such reliable recording mode:
Option 1: the entire optical disc is scanned for the erroneous data regions in unrecorded areas and upon completion, the optical recording apparatus is ready to perform the real time recording process. In such option, the two sub-steps are separated in time.
Option 2: The optical recording apparatus checks/scans the part of the optical disc. For example, the optical recording apparatus is adapted to display for the use a disc space bar (A linear bar showing on scale of 0 to 100%) and the user can set the start and end points on this bar, and, upon completion, the optical recording apparatus may begin the real time recording process.
Option 3: The optical recording apparatus performs in real time the two sub-step recording process.

Whenever an optical disc is de-iced, or first recording on a empty optical disc is initiated, then the optical recording apparatus create a “VIDEO_ES.DAT” file in the “VRM User Data” area as described hereinabove. During the progress of recording the “VIDEO_ES.DAT” will be updated every 5 seconds with as and when error sectors are encountered [or] when stop recording is invoked by the user, then VIDEO_ES.DAT file is updated at one shot.

With respect to implementation of previously described recording and formatting methods in the optical recording apparatus as described with reference to FIG. 2, it is firstly noted that the control unit 17 in a known optical recording apparatus is enabled to determine whether errors were encountered during recording a physical sector and to handle such errors. An optical recording apparatus according to the invention further comprises means 29 for generating error sector information, the error sector information comprising a list of logical sectors corresponding to the physical sectors wherein errors were encountered during recording and to provide the error sector information to the control unit 17. The control means are adapted to control the recording means to record the error sector information onto the optical disc. It is noted that in an alternative embodiment of the optical recording apparatus such means 29 for generating error sector information may be integrated into the control unit 17, for example by means of suitable programmed firmware.

With respect to implementation in a playback device of the previously described methods, preferably the control unit 17 is enabled to determining that a logical sector or a group of logical sectors wherein errors referred to in errors sector information is in playback proximity to a logical sector wherein information recorded therein is being presently played back. The apparatus may further comprise means 29 for deciding to jump the playback to information recorded to a sector succeeding the sector or a group of sectors wherein errors were encountered during recording. It is noted that said means 29a may be integrated into the control unit 17, for example by means of suitable programmed firmware.

The disclosure can be summarized as follows: this invention relates generally to a method of recording video information onto an optical disc of the rewritable type. The invention relates to determining in real time whether errors were encountered during recording a physical sector and generating error sector information comprising a list of sectors wherein errors were encountered during recording. The error sector information is recorded on disc, preferably in VRMI user data to playback compatibility with standard players. During playback, error sector are skipped from reading. Advantageously, a buffer cell is created for information recorded in error sectors so that seamless playback is possible. Advantageously, when formatting the disc, the error sector information is not deleted. Advantageously, the error sector information is used to inform the user about the disc quality.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable programmed computer. A computer program may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measured cannot be used to advantage.

1. A method of recording video information onto an optical disc of the rewritable type, the information being recorded as optically detectable marks in a recordable area of the optical disc, the recordable area being divided into independently addressable physical sectors, the physical sectors being mapped to logical sectors in a corresponding logical recording space, the information in the logical recording space being arranged according to a recording format,
the method comprising
receiving and recording the video information in real time;
determining whether errors were encountered during recording a physical sector;
generating error sector information, the error sector information comprising a list of logical sectors corresponding to the physical sectors wherein errors were encountered during recording;
recording the error sector information onto the optical disc.

2. A method according to claim 1, wherein the logical recording space of the optical disc comprising a video zone for recording said video information and for recording corresponding management information, the information in the video zone being arranged according to a video recording format, the method characterized by characterized by the error sector information being recorded into a predetermined area reserved for recording temporary information or for recording optional information for improving functionality, such as the Video Recorder Manager User Data.

3. A method according to claim 1, wherein the video information being recorded as video objects comprising a sequence of contiguously recorded cells, characterized by the method further comprising
generating an additional cell comprising the video information recorded in the physical sectors wherein errors were encountered during recording.

4. A method according to claims 3, characterized by the additional cell being a buffer cell not referenced by any playback sequences comprised in the management information.

5. A method according to claim 2, characterized by the error sector information further comprising statistical information with respect to logical sectors corresponding to physical sectors wherein errors were encountered during recording, such as the percentage of said sectors from the total number of sectors on disc.

6. A method according to claim 1, characterized by performing a pseudo-archiving step before recording the received video information
the pseudo-archiving step comprising
recording dummy information onto the optical disc,
determining whether errors were encountered during recording a physical sector with dummy information;
generating error sector information, the error sector information comprising a list of logical sectors corresponding to the physical sectors wherein errors were encountered during recording.

7. A method according to claim 6, characterized by repeating the step of pseudo-archiving and step of the recording the video information in real time as to record the video information in real time

8. A method according to claim 6, characterized by the pseudo-archiving step being preformed at a higher recording speed.

9. A method of playback of video information, the video information being recorded onto an optical disc according to claim 1, the method comprising
determining that a logical sector or a group of logical sectors wherein errors referred to in errors sector information is in playback proximity to a logical sector wherein information recorded therein is being presently played back;
deciding to jump the playback to information recorded to a sector succeeding the sector or a group of sectors wherein errors were encountered during recording.

10. A method of formatting onto an optical disc of the rewritable type, the optical disc comprising video information recorded according to claim 1;
reading the error sector information and storing said error sector information in a temporary buffer;
formatting the optical disc;
recording the error sector information.

11. An optical recording apparatus for recording video information onto an optical disc of the rewritable type, comprising
input means for receiving the video information
recording means for recording the video information being recorded as optically detectable marks in a recordable area of the optical disc, the recordable area being divided into independently addressable physical sectors, the physical sectors being mapped to logical sectors in a corresponding logical recording space,
control unit for controlling the recording means such that the information in the logical recording space being arranged according to a recording format,
the control unit being further enabled to determine whether errors were encountered during recording a physical sector;
means for generating error sector information, the error sector information comprising a list of logical sectors corresponding to the physical sectors wherein errors were encountered during recording;
the control means are adapted to control the recording means to record the error sector information onto the optical disc.

12. An optical recording apparatus according to claim 11, wherein the logical recording space of the optical disc comprising a video zone for recording said video information and for recording corresponding management information, characterized in that the control means are adapted to control the recording means to record the error sector information being recorded into a predetermined area reserved for recording temporary information or for recording optional information for improving functionality, such as the Video Recorder Manager User Data.

13. An optical recording apparatus according to claim 11, characterized in that the control means are adapted to control the recording means to record the video information as video objects comprising a sequence of contiguously recorded cells,
the control means being enabled to generate an additional cell comprising the video information recorded in the physical sectors wherein errors were encountered during recording.

14. An optical recording apparatus according to claims 13, wherein the additional cell is a buffer cell not referenced by any playback sequences comprised in the management information.

15. An optical recording apparatus according to claim 12, characterized in that the control means are enable to generate the error sector information to comprise statistical information with respect to logical sectors corresponding to physical sectors wherein errors were encountered during recording, such as the percentage of said sectors from the total number of sectors on disc.

16. An optical recording apparatus according to claim 12, characterized in that the control means are further enabled to control reading means to read the error sector information and to control the recording means to format an optical disc of the rewritable type and to recording the error sector information after formatting.

17. An optical recording apparatus according to claim 13, characterized in that the control unit being further enabled to control the optical recording apparatus to execute a pseudo-archiving step before recording the received video information
the pseudo-archiving step comprising
recording dummy information onto the optical disc,
determining whether errors were encountered during recording a physical sector with dummy information;
generating error sector information, the error sector information comprising a list of logical sectors corresponding to the physical sectors wherein errors were encountered during recording.

18. An optical playback apparatus for playback of video information, the video information being recorded onto an optical disc according to claim 1, the apparatus comprising
a control unit 17 enabled to determining that a logical sector or a group of logical sectors wherein errors referred to in errors sector information is in playback proximity to a logical sector wherein information recorded therein is being presently played back;
means for deciding to jump the playback to information recorded to a sector succeeding the sector or a group of sectors wherein errors were encountered during recording.

19. A computer software program that, when executed on suitable processor, comprising means for enabling a recording and/or a playback apparatus to execute all steps of recording method of claim 1.
